(19) United States
(12) Patent Application Publication
(10) Pub. No.: US 2008/0240439 A1
(43) Pub. Date: Oct. 2, 2008

(54) METHODS AND APPARATUS TO FACILITATE DATA AND SECURITY CONTEXT TRANSFER, AND RE-INITIALIZATION DURING MOBILE DEVICE HANDOVER

(75) Inventors: Rajat P. Mukherjee, Montreal (CA); Mohammed Sammour, Montreal (CA); Peter S. Wang, East Setauket, NY (US); Shankar Somasundaram, Deer Park, NY (US); Jin Wang, Central Islip, NY (US); James M. Miller, Verona, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/048,747

(22) Filed: Mar. 14, 2008

Related U.S. Application Data
(60) Provisional application No. 60/895,128, filed on Mar. 15, 2007.

(51) Int. Cl. H04K 1/00; G06F 21/00; H04L 9/28

(52) U.S. Cl. 380/272; 726/1

(57) ABSTRACT

Security context transfer and ROHC context transfer to enable secure and efficient mobile device handoff is facilitated by the introduction of new information elements to the UL Allocation message or separate downlink (DL) physical channel, the use of reverse tunneling during hand off (HO) to provide the User Equipment (UE) with new security parameters, the generation of multiple key sets and automated or context based triggering of the Security Mode Command.

### CROSS REFERENCE TO RELATED APPLICATIONS

This application claims the benefit of U.S. Provisional Application Ser. No. 60/895,128 filed on Mar. 15, 2007, which is incorporated by reference as if fully set forth.

### FIELD OF INVENTION

This application is related to wireless communications. More specifically it is related to facilitating the handoffs that occur as a mobile device moves from one location to another.

### BACKGROUND

The 3GPP has initiated the Long Term Evolution (LTE) program to bring new technology, new network architecture, new configuration and new applications and services in order to provide improved spectral efficiency and faster user experiences. Recently the Third Generation Partnership Project(3GPP), in the context of its Long Term Evolution (LTE) program, made a decision to move key elements of the mobile device handoff mechanism. This is the mechanism that manages mobile devices (User Equipment (UE) or mobile phones) as they move from one location to another. The User Plane Entity (UPE) Ciphering and Package Data Convergence protocol (PDCP) functionalities are being moved to the evolved Node B from the Radio Network Controller (RNC). An Evolved NodeB (eNB) (per 3GPP standards) is essentially an enhanced base transceiver station (BTS) that provides the LTE air interface and performs radio resource management for an evolved access system. Ciphering refers to the techniques used to encrypt and decode messages. One PDCP function allows message headers to be compressed, reducing transmission time and bandwidth requirements. It also includes the integrity checking functionality in the evolved system.

The relocation of the ciphering and PDCP functions has created several issues. In particular, it is necessary to evaluate how the security and PDCP contexts get transferred or re-initialized as a mobile device moves from one eNB (source) to another eNB (target). Because inter eNB handover (HO) is expected to be very frequent, an efficient scheme to transfer or re-initialize PDCP and security contexts for seamless and lossless HO between eNBs is essential. Throughout this application, the use of the term “context” is synonymous with the term “configuration.”

In the current Universal Mobile Telecommunication System (UMTS), the PDCP and security contexts are in the RNC. Current mechanisms exist to transfer these contexts during Serving Radio Network Subsystem (SRNS) Relocation (as a mobile device moves from one location to another). The current ciphering and integrity protection schemes are shown in FIGS. 1 and 2 respectively.

A Ciphering Key (CK) and an Integrity Key (IK) are generated by the Core Network (CN) and the UE respectively, using a shared secret and a random number (RAND) that is transferred from the CN to the UE during Non Access Stratum (NAS)-level authentication procedures. The Direction bit depends on whether it is an uplink (UL) or a downlink (DL). The COUNT-I for Radio Resource Control (RRC) and Radio Link Control (RLC) Protocol Data Unit (PDU)s and COUNT-C are parameters that increment every RLC PDU. The structure of the COUNT-C depends on the RLC mode used and is shown in FIG. 3.

The structure of the COUNT-I is shown in FIG. 4.

Both COUNT-C and COUNT-I are initialized by the UE and the RNC using the parameter START sent by the UE in its RRC Connection Setup Complete message. The FRESH parameter is generated by the RNC and sent to the UE in its Security Mode Command.

The CK, IK, COUNT-C, COUNT-I and FRESH parameters along with the ciphering and integrity protection procedures being used, constitute the security context that is necessary for the UE and RNC (or in the new system, the eNB) to perform ciphering and/or integrity protection. For example, an eNB and a UE must share common keys and integrity procedures in order to properly communicate data/information between them.

The RRC Context includes information elements (IE) such as UE Information Elements (e.g. Cell Radio Network Temporary Identifier (C-RNTI), UE radio access capability, etc.), CN Information Elements, measurement-related Information Elements, and Radio Bearer Information Elements, etc., which are IE's described in the SRNS Relocation Info RRC message.

PDCP functions include sequence numbering and Header Compression (e.g. RObust Header Compression (ROHC)). For each (radio) bearer, the PDCP context may include:
PDCP Sequence Number (PDCP SN), such as:
   eNB context includes UL Receive PDCP SN and DL Send PDCP SN
   UE context includes UL Send PDCP SN and DL Receive PDCP SN
ROHC context information which is described in IETF RFC3095, and in
   the IE's of the RFC 3095 Context Info RRC message, shown in Table 1 where the downlink and uplink ROHC contexts are described:

TABLE 1
ROHC Context Information

| Information Element/Group name | Semantics description |
|---|---|
| RFC 3095 context | |
| >RB identity | |
| >RFC 3095 context list | |
| >>Downlink RFC 3095 context | |
| >>>Downlink RFC 3095 context | |
| identity | |
| >>>DL MODE | RFC 3095 mode in downlink before SRNS relocation. |
| >>>REF_IR | The RTP IR header (see section 5.7.7 of RFC3095 for detailed format) |
| | corresponding to the oldest header in the compressor sliding window. |
| >>>REF TIME | Arrival time (at the compressor) of REF_IR in milliseconds. |
| | See sections 4.5.4 and 6.5.1 of RFC3095. |
| >>>CURR_TIME | Current time in milliseconds. |
| | See section 6.5.1 of RFC3095. |
| >>>SYN OFFSET ID | Last synchronized offset of IP-ID. |
| | See section 4.5.5 and 6.5.1 of RFC3095 (termed “Offset I”). |
| | It is related to the compression and decompression of IP-ID and is the |
| | synchronized offset between the IP-ID value and the SN value (in the same |
| | header) during the last SO state before the relocation procedure. |
| >>>SYN SLOPE TS | Last synchronized slope of TS. |
| | See sections 5.5.1.2 and 5.7 of RFC3095. |
| | In SO state, TS(n) = TS(m) + (n − m) * SYN_SLOPE_TS, where n and m |
| | are, the RTP SN of the current and the reference packet, respectively. |
| | The unit of SYN SLOPE TS depends on whether TS is scaled before |
| | compression or not. |
| >>>DYN CHANGED | Information whether dynamic fields other than RTP SN, RTP TS and |
| | IP-ID have changed in the headers that are stored in the sliding |
| | window. |
| | Set to TRUE if changed and FALSE if not changed. |
| >>Uplink RFC 3095 context | |
| >>>Uplink RFC 3095 context identity | |
| >>>UL MODE | RFC 3095 mode in uplink |
| >>>REF IR | The RTP IR header (see section 5.7.7 of IETF RFC3095 for detailed |
| | format) corresponding to the last correctly decompressed header. |
| >>>REF TIME | Arrival time (at the decompressor) of REF_IR in milliseconds. |
| | See sectionss 4.5.4 and 6.5.1 of RFC3095. |
| >>>CURR_TIME | Current time in milliseconds. See section 6.5.1 of RFC3095. |
| >>>SYN OFFSET ID | Last synchronized offset of IP-ID. |
| | See sectionss 4.5.5 and 6.5.1 of RFC3095 (termed“Offset I”). |
| | It is related to the compression and decompression of IP-ID and is the |
| | synchronized offset between the IP-ID value and the SN value (in the |
| | same header) during the last SO state before the relocation procedure. |
| >>>SYN SLOPE TS | Last synchronized slope of TS. |
| | See sectionss 5.5.1.2 and 5.7 of RFC3095. |
| | In SO state, TS(n) = TS(m) + (n − m) * SYN_SLOPE TS, where n and m |
| | are, the RTP SN of the current and the reference packet, respectively. |
| -REF SN_1 | Corresponds to the RTP Sequence Number of the predecessor of the |
| | latest RTP packet. This could be used to perform local repair of context |
| | by decompressor in U or 0 mode (see “ref-1” in section 5.3.2.2.5 in |
| | IETF RFC3095 for further explanation). |

Traditionally, the SRNS Relocation RRC message allows the source RNC (s-RNC) to indicate to the target RNC (t-RNC) the security and RRC context. For security context, if applicable, the Ciphering and Integrity Protection IE's are set to Started. If the IEs are set to Started, then the s-RNC forwards the CK, IK, COUNT-C, COUNT-I and START values to the t-RNC. The s-RNC does not pass the FRESH parameter at this time. The target RNC is expected to generate the FRESH parameter and send it in a Security Mode Command when lower layer setup is complete.

During SRNS Relocation, the s-RNC transfers the PDCP ROHC Context (Table 1) by using the RRC RFC 3095 Context Info message.

FIGS. 5A-5B shows an example of accepted inter eNB HO signaling procedure. After Area Restriction 500 has been provided (this procedure determines the cells to which the WTRU 510 cannot connect), measurement control 501 is executed (various measurements are taken such as signal strength, etc.), packet data (user data) is sent to the source eNB 520 and is forwarded by source eNB 520 to the WTRU 510. The source eNB 520 allocates an uplink channel 507 and a variety of measurement reports 509 are generated. Based on the measurement reports 509 (and various other network procedures such as load balancing procedures, etc.), a handover decision 511 is made by the source eNB 520. The source eNB 520 issues a Handover Request message 513 to the target eNB 530 passing necessary information to prepare the HO at the target side (WTRU X2 signaling context reference at source eNB 510, WTRU S1 Evolved Packet Core (EPC) signaling context reference, target cell ID, RRC context, System Architecture Evolution(SAE) bearer context). WTRU X2/WTRU S1 signaling references enable the target eNB 530 to address the source eNB 520 and the EPC. The SAE bearer context includes necessary Radio Network Layer (RNL) and Transport Network layer (TNL) addressing information.

Admission Control 515 may be performed by the target eNB 530 dependent upon the received SAE bearer Quality of Service (QoS) information to increase the likelihood of a successful HO, if the resources can be granted by the target eNB 530. The target eNB 530 configures the required resources according to the received SAE bearer QoS information and reserves a C-RNTI.

In preparation for HO, the Target eNB 530 assigns the WTRU 510 with L1/L2 configuration information that the WTRU 510 must use when it moves to the target eNB 530 and sends this information in a transparent container during the Handover Request Ack message 517 to the source eNB 520. The Handover Request Ack message 517 includes the transparent container as part of the Handover Command 521 to be sent to the WTRU 510. The container may also include new C-RNTI, and possibly some other parameters such as access parameters, System Information Blocks (SIBS), etc. The Handover Request Ack message 517 may also include RNL or TNL information for the forwarding tunnels.

The source eNB 520 allocates a downlink (DL) channel 519 that is used to send target cell radio configuration information. The source eNB 520 transmits the Handover Command 521 (RRC message) to the WTRU 510. The Handover Command 521 includes the transparent container, which has been received from the target eNB 530. The source eNB 520 performs the necessary integrity protection and ciphering of the message. The WTRU 510 receives the Handover Command 521 with necessary parameters (i.e. new C-RNTI, possible starting time, target eNB SIBS, etc.) and is commanded by the source eNB 520 to perform the HO. Typically, the WTRU 510 also needs to acknowledge reception of the Handover Command 521 with an RLC acknowledgment procedure. The WTRU 510 detaches from the old cell and synchronizes to the new cell 525 and buffered or in transit data packets 527 are delivered to target eNB 530 via DL data forwarding link 529.

Synchronization 533 is then performed between the WTRU 510 and the target eBN 530. The target eNB 530 also allocates an Uplink (UL) channel 535 to the WTRU 510 that is used to transfer, among other things, timing advance information. When the WTRU 510 has successfully accessed the target cell, the WTRU 510 sends the Handover Confirm message 539 (which includes the C-RNTI received in the Handover Command message 521) to the target eNB 530 to indicate that the handover procedure has completed. The target eNB 530 verifies the C-RNTI sent in the Handover Confirm message 539. User data destined for the WTRU 510 during this phase continues to be buffered by the source eNB and forwarded to the target eNB 530. The eNB 530 then sends a HO complete message 543 to the Mobile Management Entity (MME)/SAE gateway 540. Path switching 545 can now be completed. The MME/SAE gateway 540 sends a HO complete ack 547 to the target eNB 530. The target eNB 530 then issues a resource release command to the source eNB 520. The source eNB 520 then flushes the DL buffer and continues to deliver in transit packets 551 to the target eNB 530 via DL data forwarding link 553. The source eNB 520 releases resources associated with WTRU 510. New packet data 555 now goes directly to the new source eNB 530 (formerly the target eNB 530) and on to the WTRU 510 via new downlink channels 559.

3GPP also specifies that the Mobile Management Entity (MME)/SAE Gateway 300 shall be ignorant of any mobility within the E-UTRAN until the path switching stage.

The 3GPP decision to move UPE ciphering and PDCP functionalities from the RNC to the eNB creates issues. These issues include the following:

1) The same security parameters (such as the LTE equivalents of the ciphering and integrity protection keys—henceforth referred to as CK and IK respectively—for control and user plane signaling) and the same procedure will be used to cipher and protect data integrity for a given WTRU as that WTRU transitions into a new cell. This represents a potential security risk. The FRESH parameter and the related security procedures should be changed as the other security parameters are generated or initialized using parameters from the WTRU or the CN. The target eNB should be allowed to change the FRESH parameter and/or the ciphering/integrity protection procedures used during HO.

2) Handoffs between eNBs are expected to be frequent, thus making it impractical for the target eNB to initiate a Security Mode Command (to provide a WTRU with the FRESH parameter) for each Handover because this could cause undesirable service interruptions.

3) There is no procedure that supports or achieves effective and efficient security context transfer for LTE systems.

4) There is no procedure that supports or achieves the PDCP/ROHC context transfer for LTE systems.

5) Not all eNB's may be capable of supporting context transfer, thus context transfer support may be optional due to the complexity it introduces in the LTE network. This issue may also exist for the security context as well.

6) The target eNB and/or the WTRU should be allowed to either transfer the header compression context or re-initialize it. In case of re-initialization, it is important to devise a fast re-initialization procedure in order to minimize being in a sub-optimal or inefficient state.

7) Finally, no effective mechanisms exist to facilitate PDCP/ROHC and security context retrieval or re-initialization during failure scenarios.

### SUMMARY

A method and apparatus are disclosed to facilitate header compression, security context transfer and/or re-initialization during the handover process that occurs as a mobile device moves from one location to another. Issues introduced by the 3GPP decision to move ciphering and PDCP functionalities from the RNC to the eNB are resolved by the introduction of new information elements to the UL Allocation message or separate DL physical channel, the use of reverse tunneling during HO to provide WTRU with new security parameters, the generation of multiple key sets and automated or context based triggering of the Security Mode Command.

### BRIEF DESCRIPTION OF THE DRAWINGS

A more detailed understanding may be had from the following description, given by way of example in conjunction with the accompanying drawings wherein:

FIG. 1 shows a common Ciphering Procedure;

FIG. 2 shows a common Integrity Protection Procedure;

FIG. 3 is a COUNT-C Structure;

FIG. 4 is a COUNT-I Structure;

FIGS. 5A-5B show a conventional implementation of security context transfer;

FIGS. 6A-6C show an embodiment of security context transfer with new information elements;

FIGS. 7A-7C show an embodiment of security context transfer with new information elements assuming multiple target eNBs initially solicited;

FIGS. 8A-8C show an embodiment of reverse tunneling of a security context;

FIGS. 9A-9C show an embodiment of fast re-initialization (or refresh) of ROHC context;

FIGS. 10A-10C show an alternative embodiment of fast re-initialization (or refresh) of ROHC context; and

FIGS. 11A-11C show an embodiment using multiple key generation.

FIG. 12 is an example functional block diagram of a WTRU and an eNB.

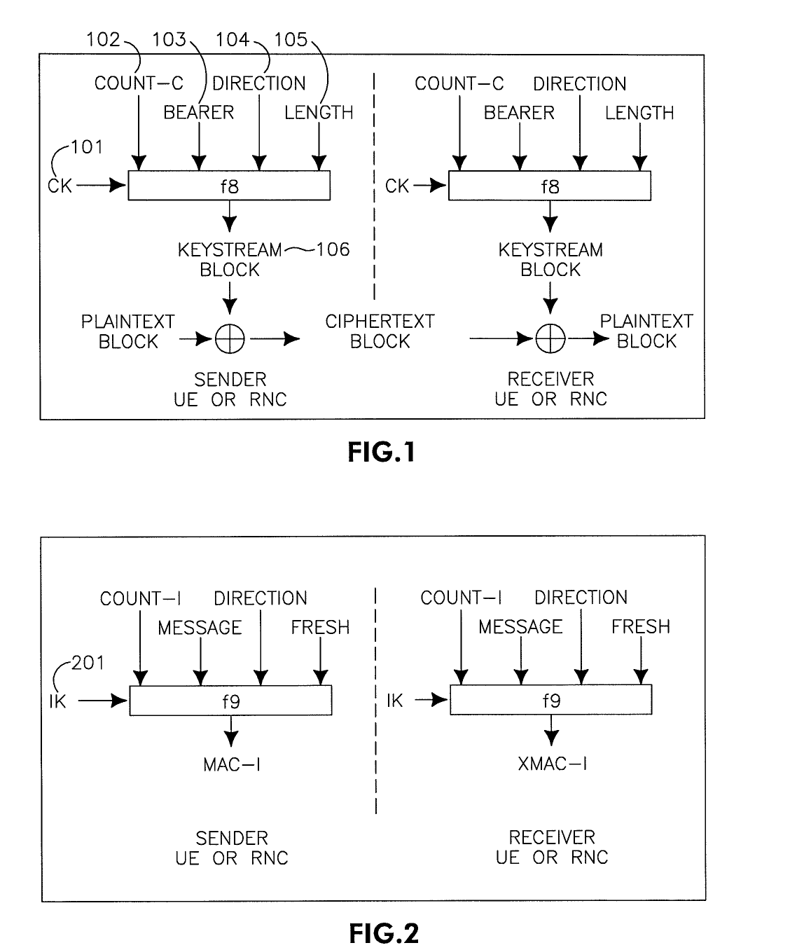

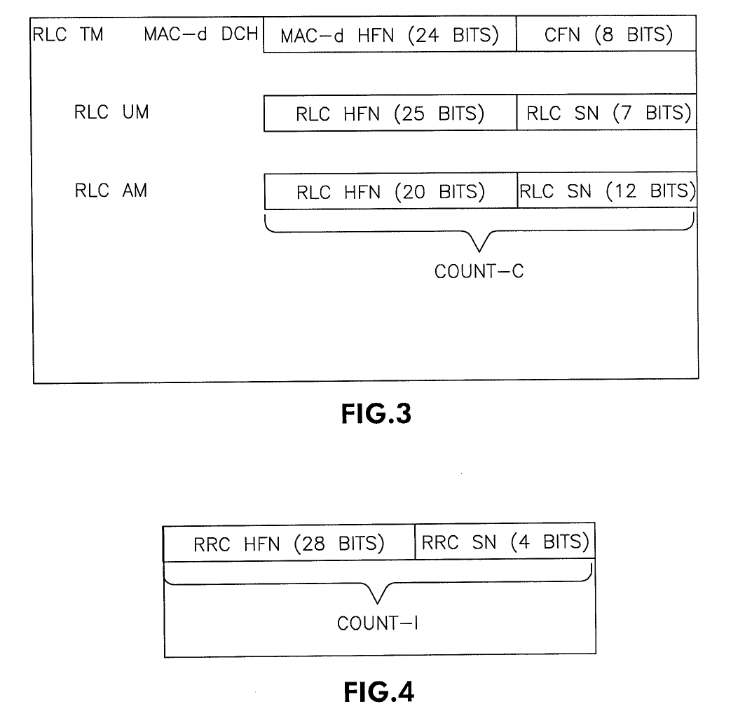

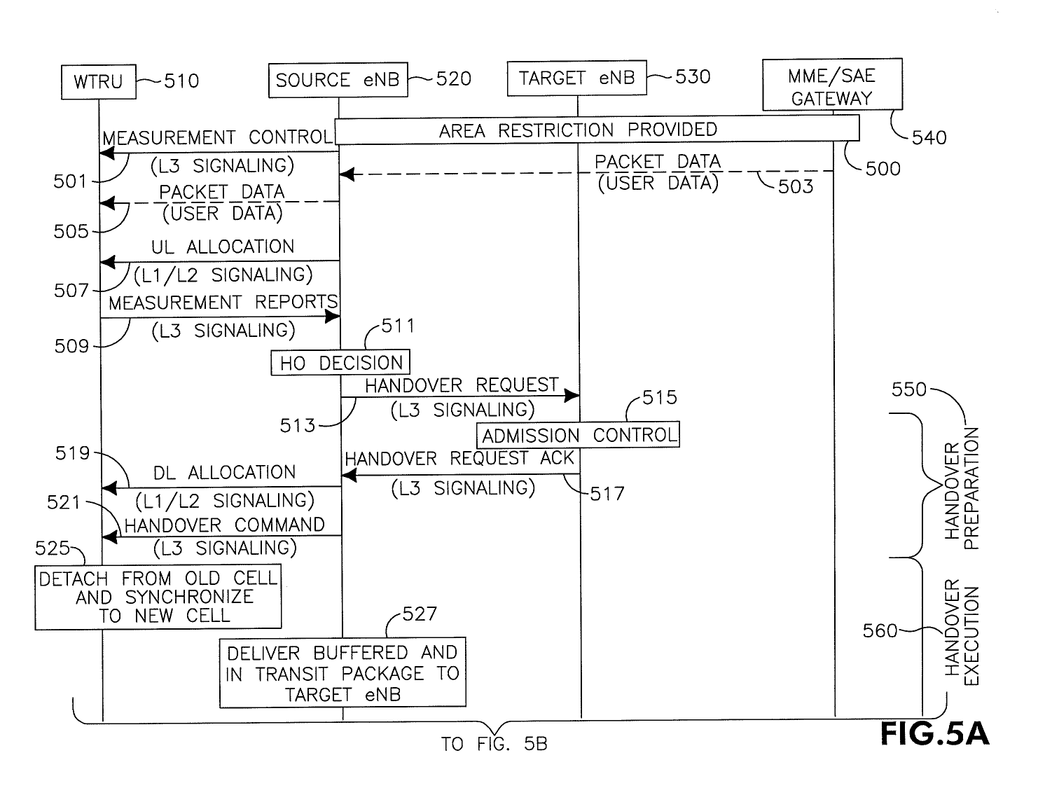

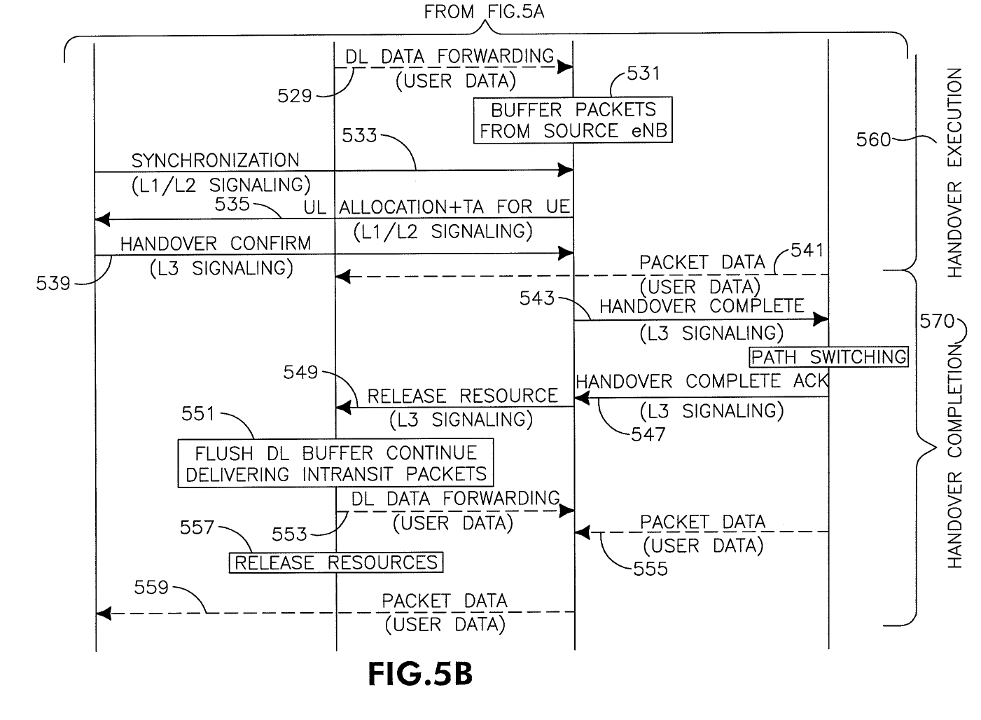

### DETAILED DESCRIPTION

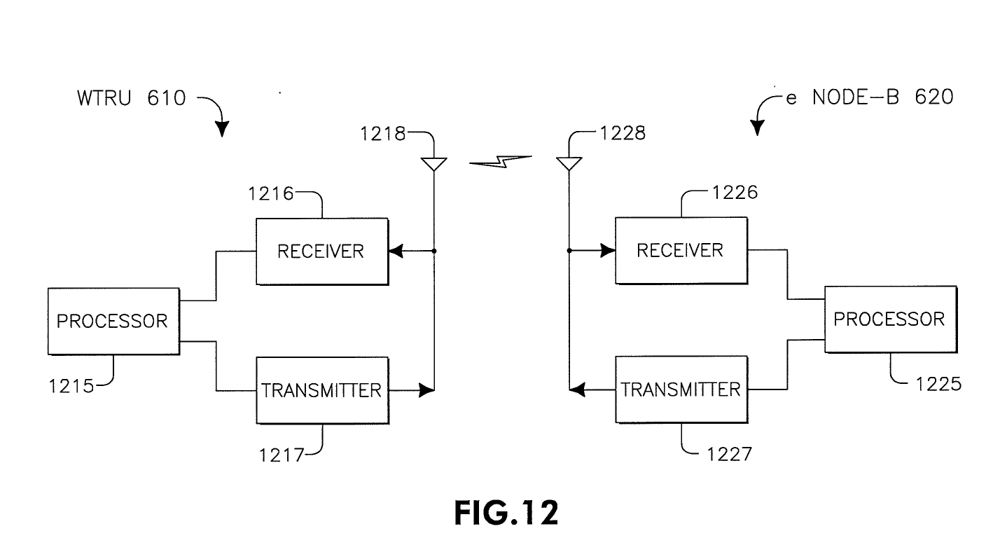

FIG. 12 is a functional block diagram of a WTRU 610 and the eNB 620. As shown in FIG. 12, the WTRU 610 is in communication with the eNB 620 and both are configured to perform a method of security and PDCP context transfer during a handover procedure.

In addition to the components that may be found in a typical WTRU, the WTRU 610 includes a processor 1215, a receiver 1216, a transmitter 1217, and an antenna 1218. The processor 1215 is configured to perform a method of security and PDCP context transfer during a handover procedure. The receiver 1216 and the transmitter 1217 are in communication with the processor 1215. The antenna 1218 is in communication with both the receiver 1216 and the transmitter 1217 to facilitate the transmission and reception of wireless data.

In addition to the components that may be found in a typical eNB, the eNB 620 includes a processor 1225, a receiver 1226, a transmitter 1227, and an antenna 1228. The processor 1225 is configured to perform a method of security and PDCP context transfer during a handover procedure. The receiver 1226 and the transmitter 1227 are in communication with the processor 1225. The antenna 1228 is in communication with both the receiver 1226 and the transmitter 1227 to facilitate the transmission and reception of wireless data.

Transfer and Fast Re-initialization of Security Context

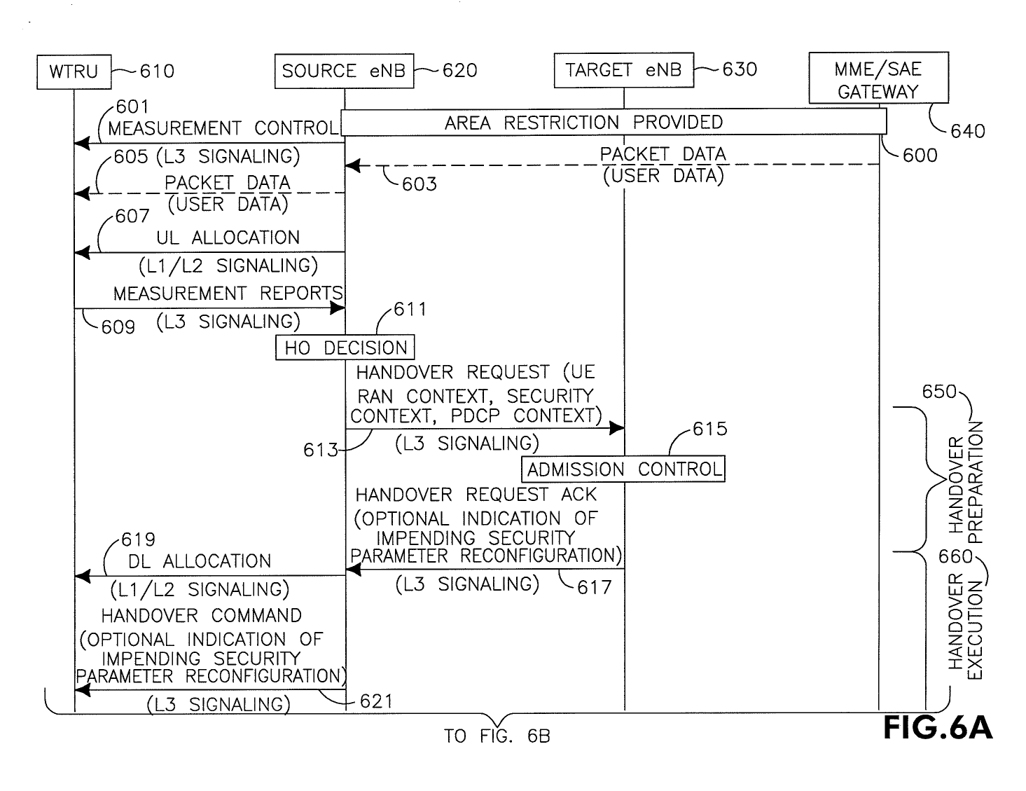

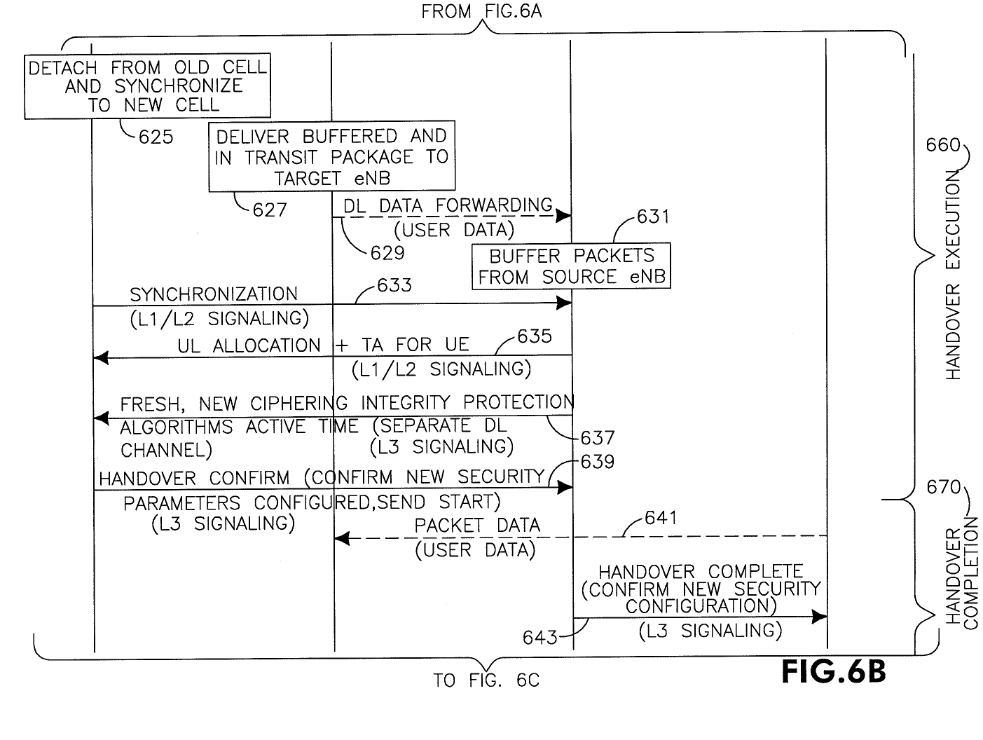

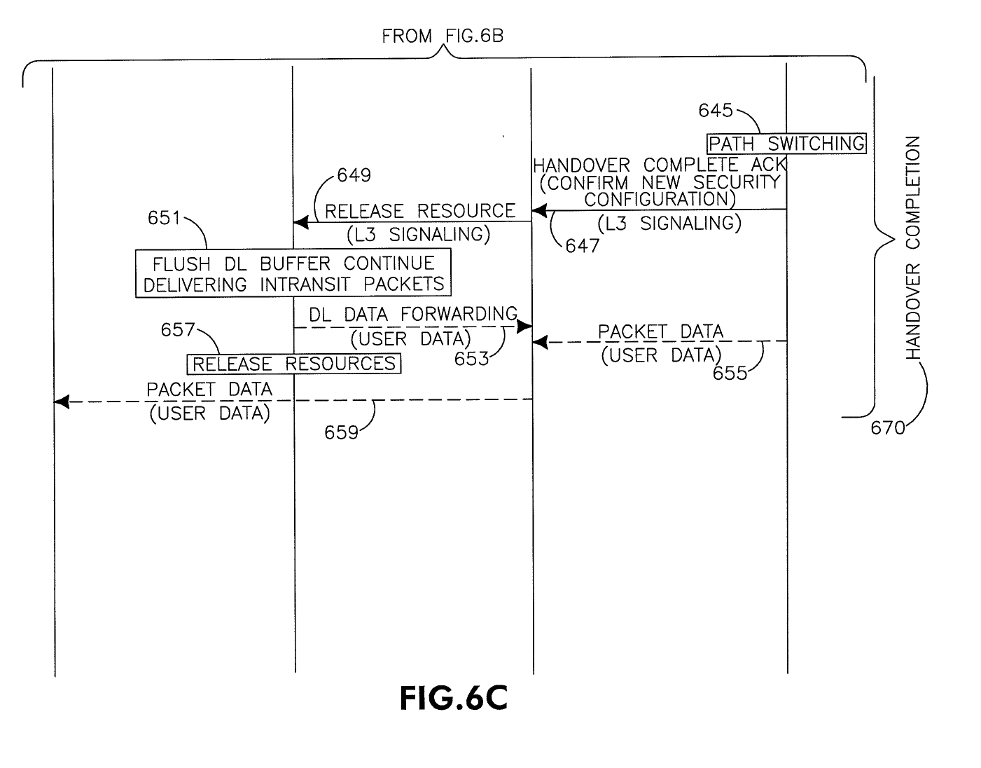

A first embodiment of security context transfer is shown in FIGS. 6A-6C. In this case, the target eNB 630 changes FRESH and/or security procedures used before Handover Confirm 639 by the WTRU 610. After Area Restriction 600 has been provided (this procedure determines the cells to which the WTRU 610 cannot connect), measurement control 601 is executed (various measurements are taken such as signal strength, etc.), packet data (user data) is sent to the source eNB 620 and is forwarded by source eNB 620 to the WTRU 610. The source eNB 620 allocates an uplink channel 607 to WTRU 610 and a variety of measurement reports 609 are generated. Based on the measurement reports 609 (and various other network procedures such as load balancing procedures, etc.), a handover decision 611 is made by the source eNB 620. After the source eNB 620 makes the HO decision 611 to a particular target eNB 630, it sends the current security context, as well as the WTRU radio access network (RAN) context, to the target eNB 630 in a Handover Request message 613. This message includes values for the following: a CK, IK, MAC-d hyper frame number (HFN), RRC HFN, RLC HFN and START. The WTRU RAN context includes radio bearer information and transport channel configuration information. The current FRESH value may also be sent to the target eNB 630 in this message. Typically, RLC and RRC SN's are not sent to reduce message size. These sequence numbers are either re-initialized during HO or are obtained from the headers. However, if space permits they may be sent as well.

Admission Control 615 may be performed by the target eNB 630 dependent upon the received SAE bearer Quality of Service (QoS) information to increase the likelihood of a successful HO, if the resources can be granted by the target eNB 630. The target eNB 630 configures the required resources according to the received SAE bearer QoS information and reserves a C-RNTI. The target eNB 630 confirms (such confirmation may include a success indicator and/or it may include any combination of elements comprising the security context) the context transfer in the Handover Request Ack message 617 and may include a message that is to be passed transparently to the WTRU 610 by the source eNB 620 (in the HO Command 621) indicating the target eNB's 630 intention to change security configurations (security procedure and/or integrity procedure). Upon receiving the confirmation of the context transfer, the source eNB 620 allocates a downlink channel 619 and issues the HO Command 621 to the WTRU 610.

The WTRU 610 then detaches from the old cell and synchronizes to the new cell 625. In 627, any buffered or in transit data packets are delivered to the target eNB 630 via the X2 interface 629 as shown by 631.

This method assumes: (1) that the HO decision 611 is made late (near the time that the HO will be actually executed); and (2) that only one target eNB 630 is selected. If the HO decision 611 is made significantly in advance of the time HO is actually needed/executed, then some of the information exchanged in the Handover Request message 613 or the Handover Request Ack message 617 may get stale.

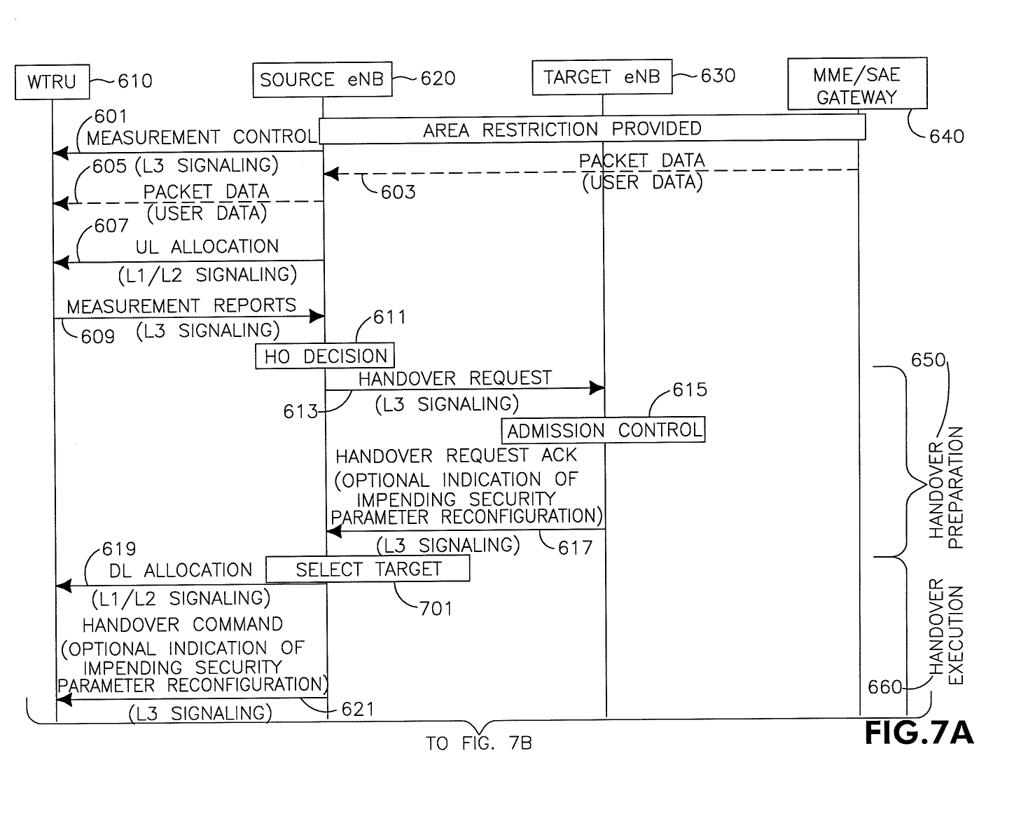

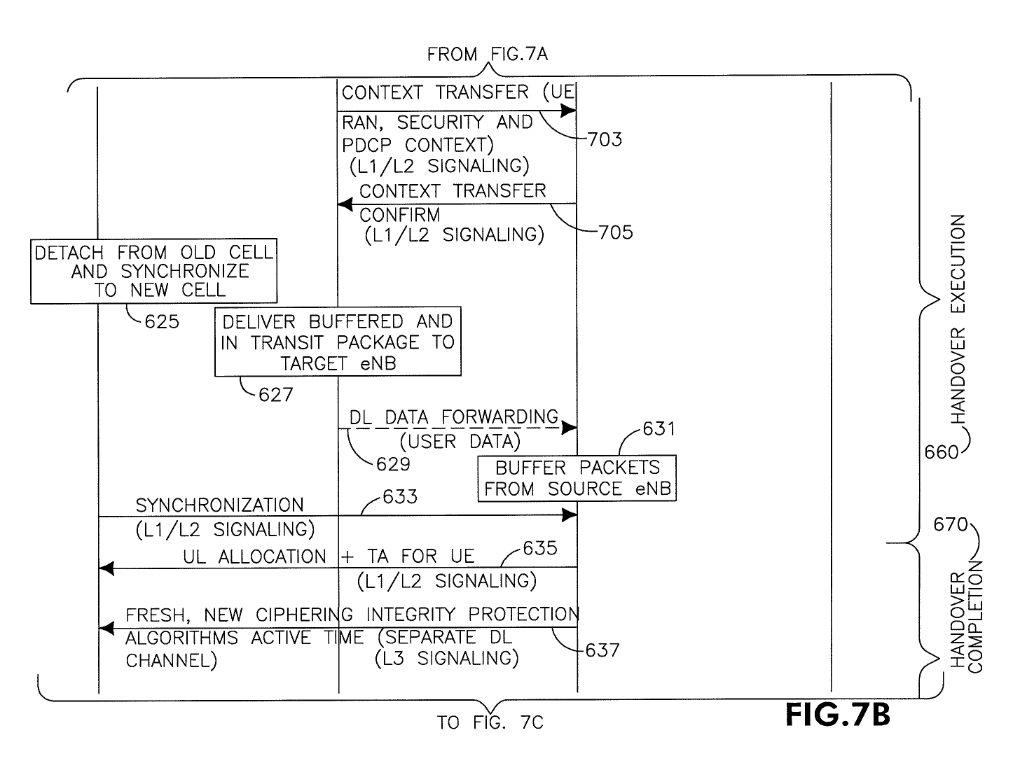

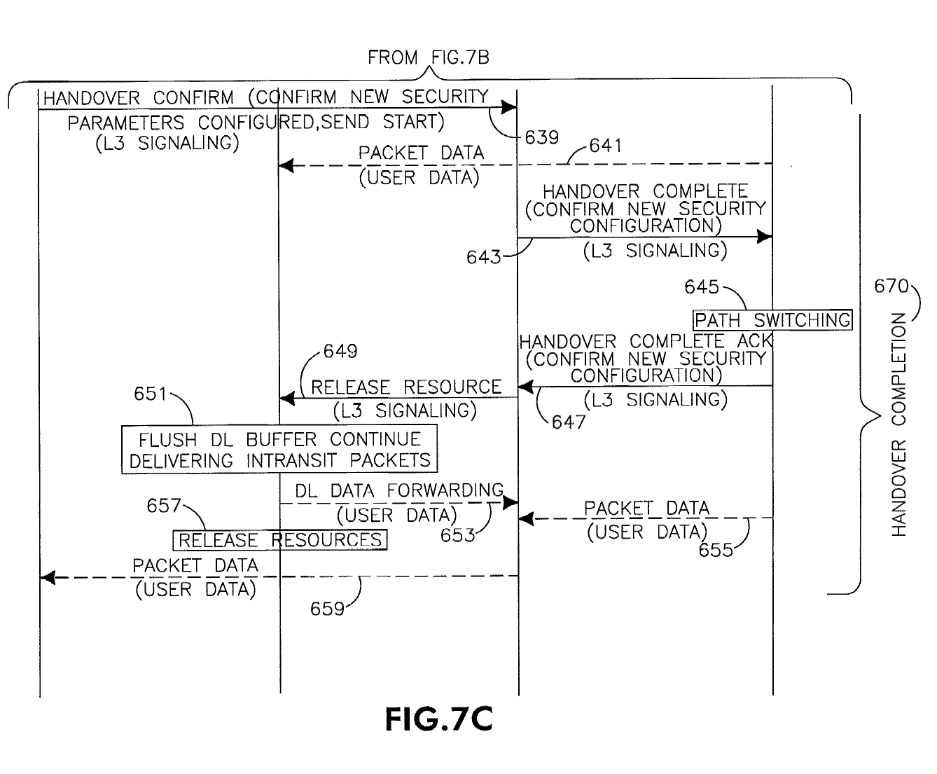

Alternatively, as shown in FIGS. 7A-7C, it is possible to solicit multiple target eNBs in using multiple Handover Request messages. In which case, or as an alternative embodiment, it may be unnecessary to send the security and PDCP contexts to every potential target in an Handover Request message 613. In this case, the source eNB 620 may wait for the multiple Handover Request Ack messages 617 to be received before selecting a target 701 eNB 630. The source eNB 620 will then initiate a context transfer of PDCP and security context (or the portion that might not have been sent in the Handover Request message 613, or the portion that might have gotten stale) to the target eNB 630. Such exchange of context information may be performed near (just before) the time that HO will be actually executed in order to insure the accuracy of the context information (that it is not stale). Simultaneously (or while context transfer is in progress or after the context transfer is completed) the source eNB 620 will send the Ho Command 621 to the WTRU 610. If the target eNB 630 had indicated in its HO Request Ack message 617 that a security parameter reconfiguration would occur, the source eNB 620 may choose to wait for the confirmation of a successful context transfer before initiating the HO Command 621. In this example, referring to FIGS. 7A-7C, the source immediately initiates HO (and does not wait for the completion of the context transfer). When the context transfer has completed, the target eNB 630 will respond with a context transfer confirm message 705.

In either case, the WTRU 610 then synchronizes 633 with the target eNB 630 upon which the target eNB 630 sends the WTRU 610 an Uplink Allocation message 635 in order to allocate uplink resources to the WTRU 610. In addition, downlink resources are also allocated in a separate DL channel 637. The target eNB 630 may choose to use either the UL Allocation message 635 or the separate DL channel 637 to change the ciphering procedure, the integrity protection procedure, the FRESH parameter, or any combination of the above. In addition, the target eNB 630 may indicate the ciphering activation time (default is “immediately”). The WTRU 610 will confirm (such confirmation may include a success indicator and/or it may include any combination of elements comprising the security context) these changes using an HO Confirm message 639 and may choose to send a new START parameter. Finally, the target eNB 630 should communicate these changes to the MME/SAE Gateway 640 in its Handover Complete message 643 (FIGS. 6A-6C and 7A-7C) to allow the actual path switching 645 to occur and the MME/SAE Gateway 640 should confirm (such confirmation may include a success indicator and/or it may include any combination of elements comprising the security context) these new parameters in a Handover Complete Ack message 647 (see FIGS. 6A-6C and 7A-7C) to the target eNB 630.

A target eNB may indicate the changes to the WTRU by including IE's called ‘Ciphering’ and ‘Integrity Protection’ in UL Allocation message 635 or in the separate DL channel 637 as shown in FIGS. 6A-6C and 7A-7C, and below in Tables 2 and 3 respectively.

TABLE 2
Ciphering IE in UL Allocation Message

| Ciphering | Description |
|---|---|
| Ciphering status | Enumerated |
| | (Same, Modify) |

TABLE 3
Integrity Protection IE in UL Allocation Message

| Integrity protection | Description |
|---|---|
| Integrity protection status | Enumerated |
| | (Same, Modify) |

If the Ciphering status in the Ciphering IE is set to ‘Modified’ then the target eNB 630 will also include an IE that indicates the particular ciphering procedure to be used (UEA0, UEA1, UEA2 or other) during UL Allocation 635 or in the separate DL channel 637 as shown in FIGS. 6A-6C and 7A-7C, and as indicated in Table 4 below.

TABLE 4
IE to indicate change in ciphering procedure

| Information Element/Group name | Description |
|---|---|
| Ciphering procedure | Enumerated |
| | (UEA0, UEA1, UEA2, . . . ) |

If the ciphering status in the Ciphering IE is set to ‘Same’ then the target eNB 630 and WTRU 610 will automatically use the ciphering procedure used in the source eNB 620.

Similarly if the Integrity Protection Status is set to ‘Modify’ then the target eNB 630 will also include an IE that indicates, among other things, the integrity protection procedure to be used (UIA1, UIA2 or other) and the FRESH value to be used during UL Allocation 635 or in the separate DL channel 637 as shown in FIGS. 6A-6C and 7, and as indicated in Table 5 below.

TABLE 5
IE's to indicate change in integrity protection
procedure and/or FRESH value

| Information Element/Group name | Type and reference | Description |
|---|---|---|
| Integrity protection procedure | Enumerated | |
| | (UIA1, UIA2, . . . ) | |
| Integrity protection initialization | Bit string(32) | FRESH |
| number | | |

A target eNB may choose to protect the security messages by ciphering and integrity protecting the entire message (or only the security related parts) using the parameters passed to it by the source eNB. Other variations may allow the target eNB to initialize the START/COUNT-C/COUNT-I parameters (this will require a change to current security procedures). This procedure assumes current UMTS Authentication and Key Agreement (AKA) procedures and procedures, but it is also designed to meet the requirements of any potential LTE Security and Key Agreement procedures. Essentially, the target eNB makes the decision regarding ciphering and integrity checking and the WTRU and source eNB act accordingly.

Reverse Tunneling of New Security Parameters

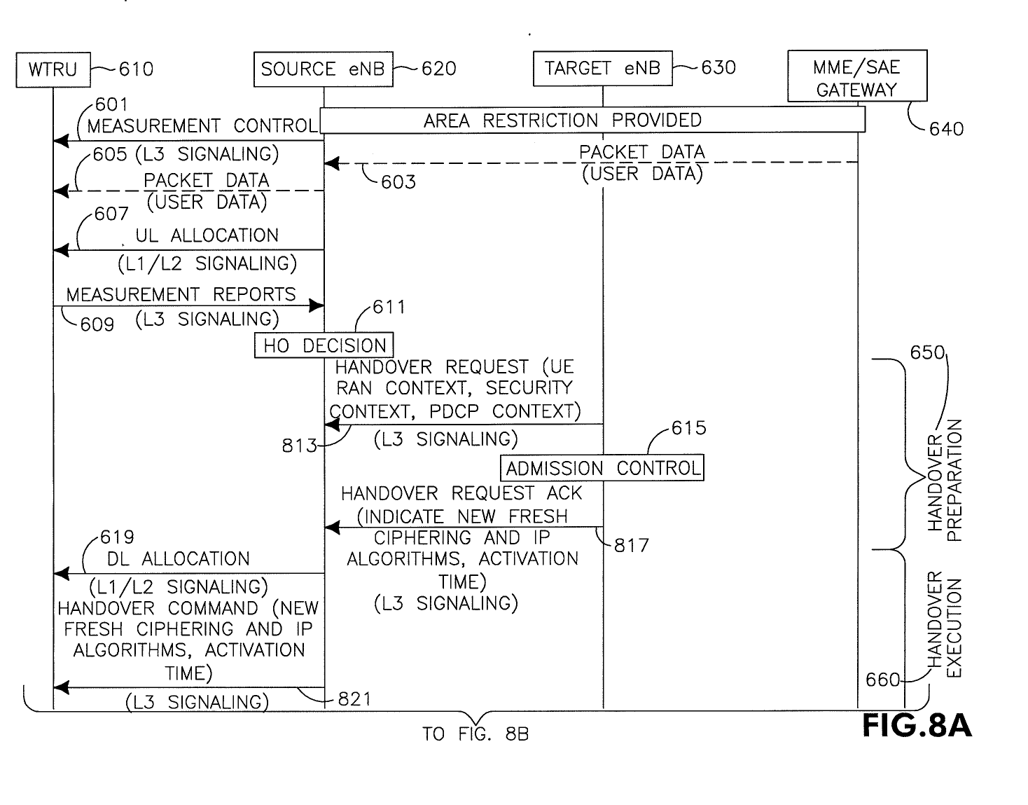

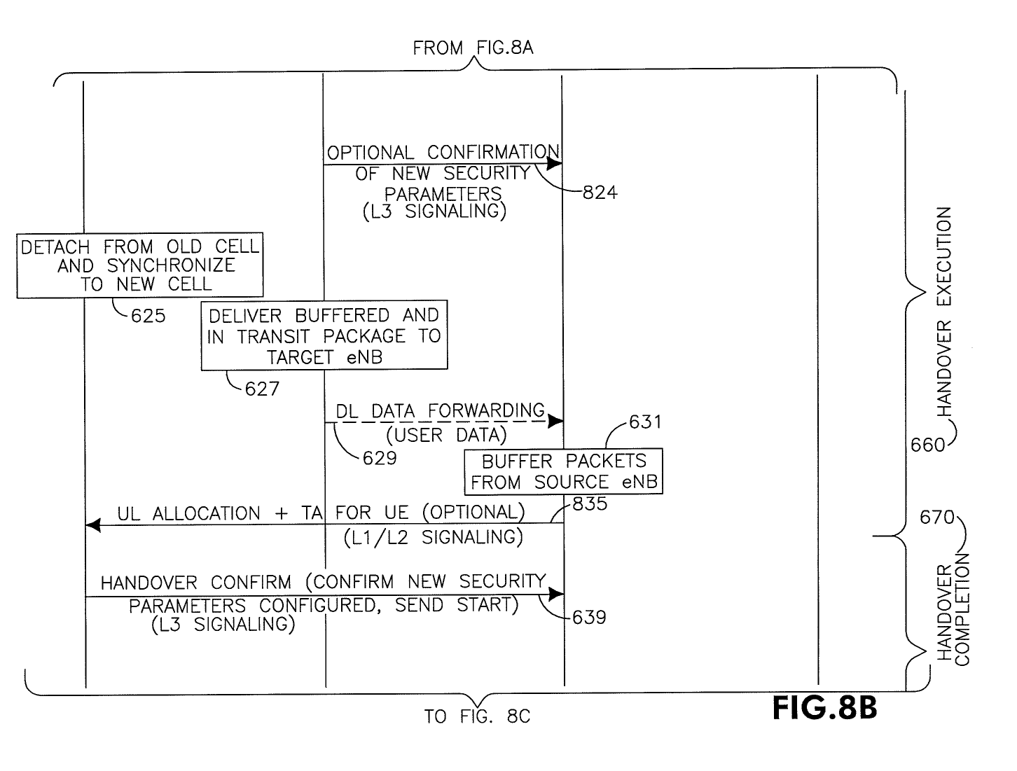

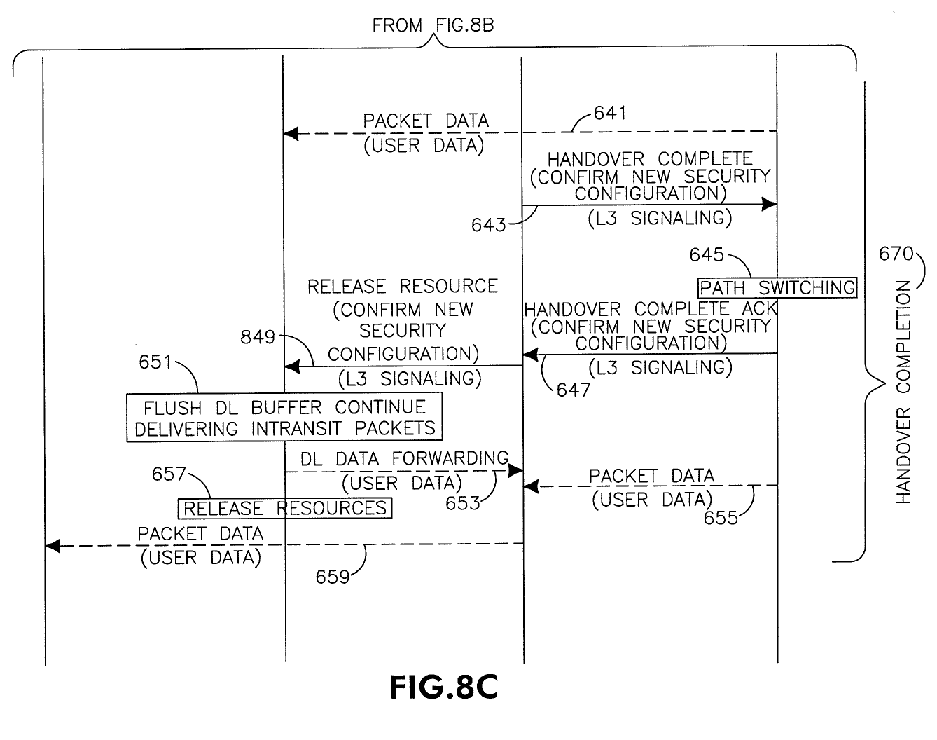

FIGS. 8A-8C shows an alternative embodiment utilizing reverse tunneling of new security parameters.

During the HO preparation stage 650, the source eNB 620 sends a Handover Request message 813 to the target eNB 630 that provides the target eNB 630 with the current security context as described in the first embodiment. This is essential, as otherwise the target eNB 630 has no access to the keys being used (the MME/SAE Gateway 640 does not assist intra MME/SAE Gateway HO as per the previously mentioned 3GPP assumption). In the Handover Request Ack message 817, the target eNB 630 may provide a FRESH parameter and an indication of the ciphering/integrity protection procedures to be changed. In addition, the target eNB 630 may indicate the activation time for ciphering (default is ‘immediately’). The source eNB 620 may then transparently forward this information to the WTRU 610 in its Handover Command message 821 using the IE's described in the first embodiment. Simultaneously, the source eNB 620 may optionally confirm (such confirmation may include a success indicator and/or it may include any combination of elements comprising the security context) receiving the new security parameters 824 to the target eNB 630. Otherwise the target eNB 630 may treat the radio layer access by the WTRU 610 as an implicit confirmation of successful reception of the context confirm message by the source eNB 620.

Another variation is to assume that initial context transfer and reverse tunneling are not accomplished as part of the HO Request 613, but instead are implemented as a separate Context Transfer message 703 and a Context Transfer Confirm message 705 (as shown in FIGS. 7A-7C). However, in the case of reverse tunneling, the source will have to wait for the completion of context transfer before initiating HO Command message 621, as Context Transfer Confirm message 705 message contains important security and PDCP reconfiguration parameters.

Generation of Multiple Key Sets During Initial Security Negotiations and Forwarding them During HO

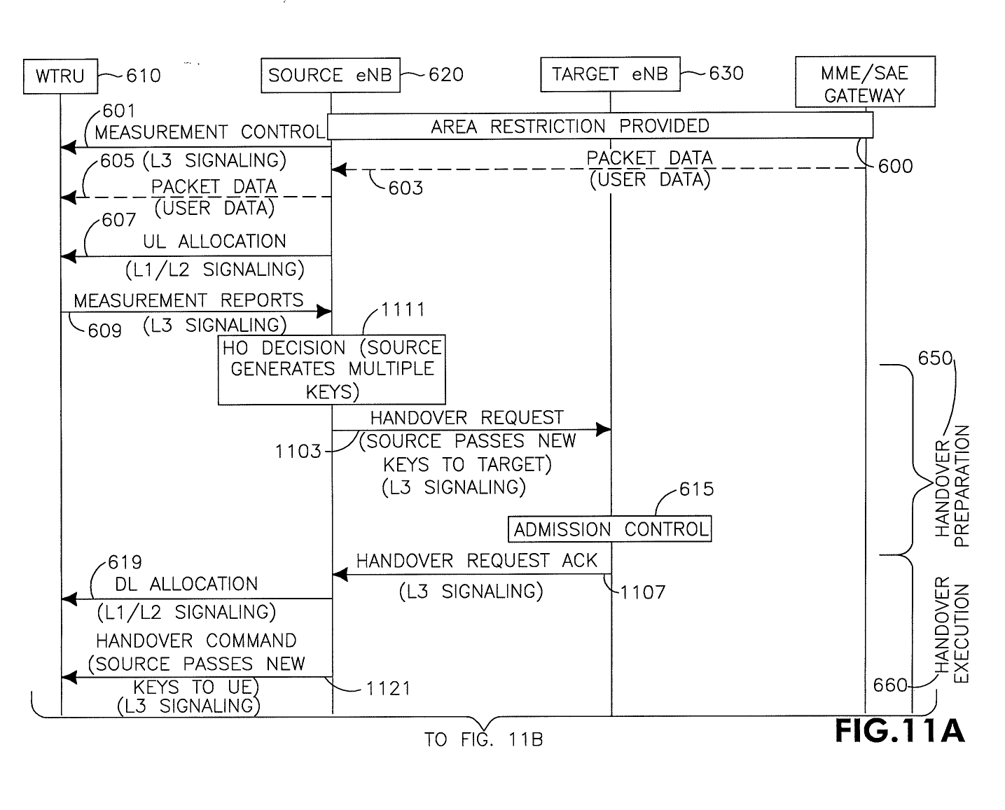

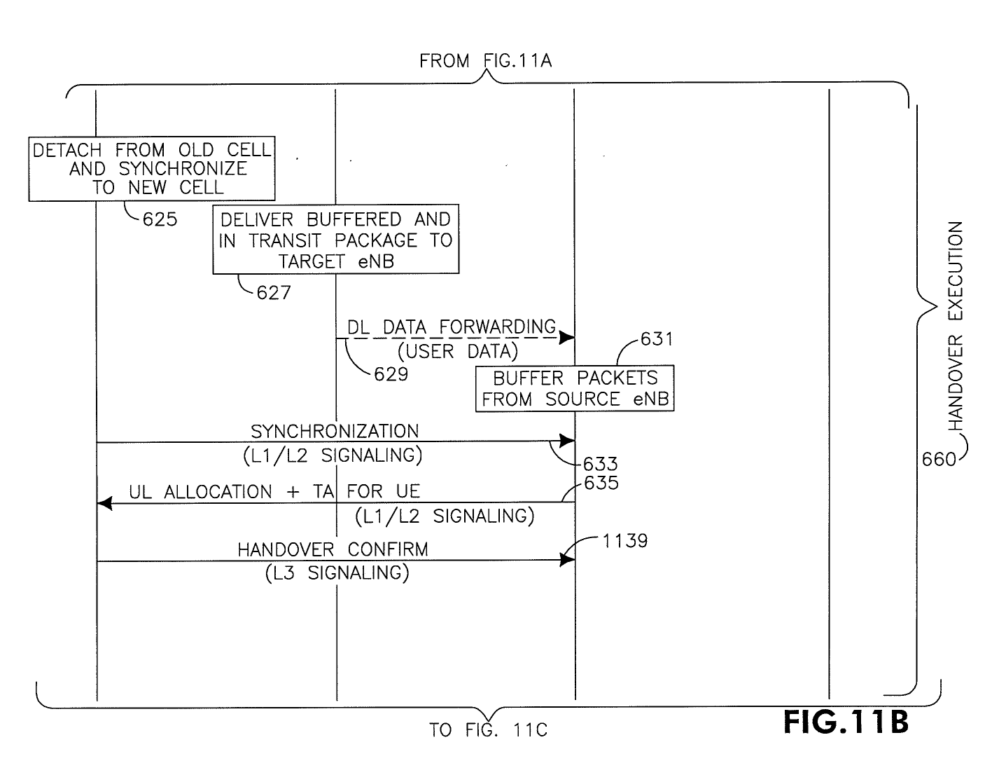

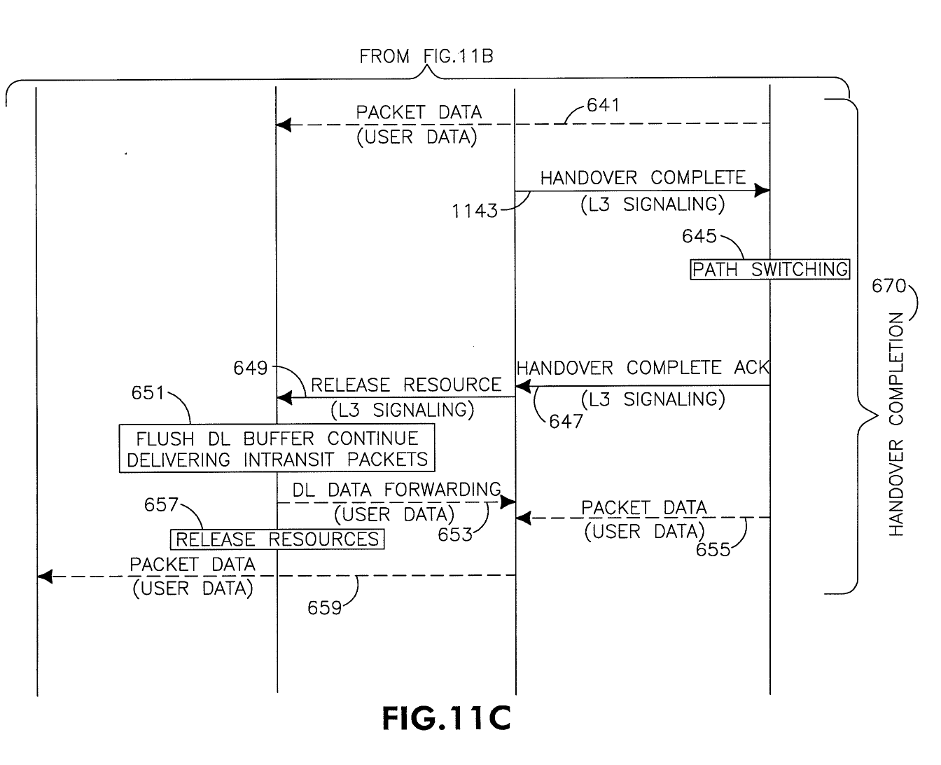

In another embodiment, described in FIGS. 11A-11C the source eNB 620 generates one or more CK/IK pairs during HO Decision 1111. The source eNB 620 then transfers one set of CK/IK pairs to the target eNB 630 in the HO Request 1103.

During HO Command 1121, the source eNB 620 transfers the security context, which includes the CK/IK pair to be used at the target and associated hyper frame number (HFN) counts, etc., to the WTRU 610.

Now that the WTRU 610 and target eNB 630 are using the same ciphering and integrity procedures, handover may proceed. The WTRU 610 detaches from the source eNB 620 (any buffered or in transit packets are delivered to the target eNB 630). The WTRU 610 synchronizes (Synchronisation 8) with the target eNB 630 which will ultimately become the new source eNB. The target eNB 630 issues an UL Allocation message 635 to the WTRU 610. The WTRU 610 issues a HO Confirm message 1139 (such confirmation may include a success indicator and/or it may include any combination of elements comprising the security context) to the target eNB 630 which then notifies the MME/SAE Gateway 640 that handover has completed via HO complete message 1143. When the MME/SAE Gateway 640 responds with a HO Complete Ack 647, the handover is now complete. Any packets destined for the WTRU 610 (other than those that were in-transit prior to handover completion—these continue to be forwarded by the old source eNB 620) will now go directly to the new source eNB (formerly target eNB 630).

Automated Initiation of NAS User Authentication Request Upon Reception of HO Complete

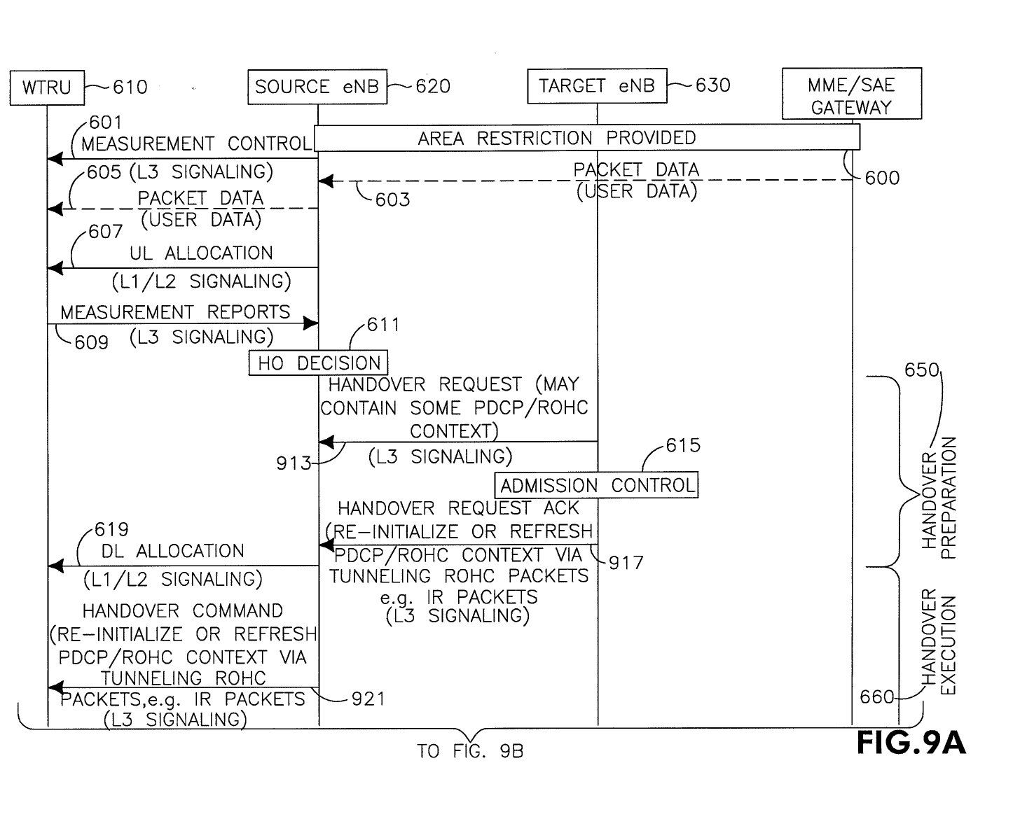

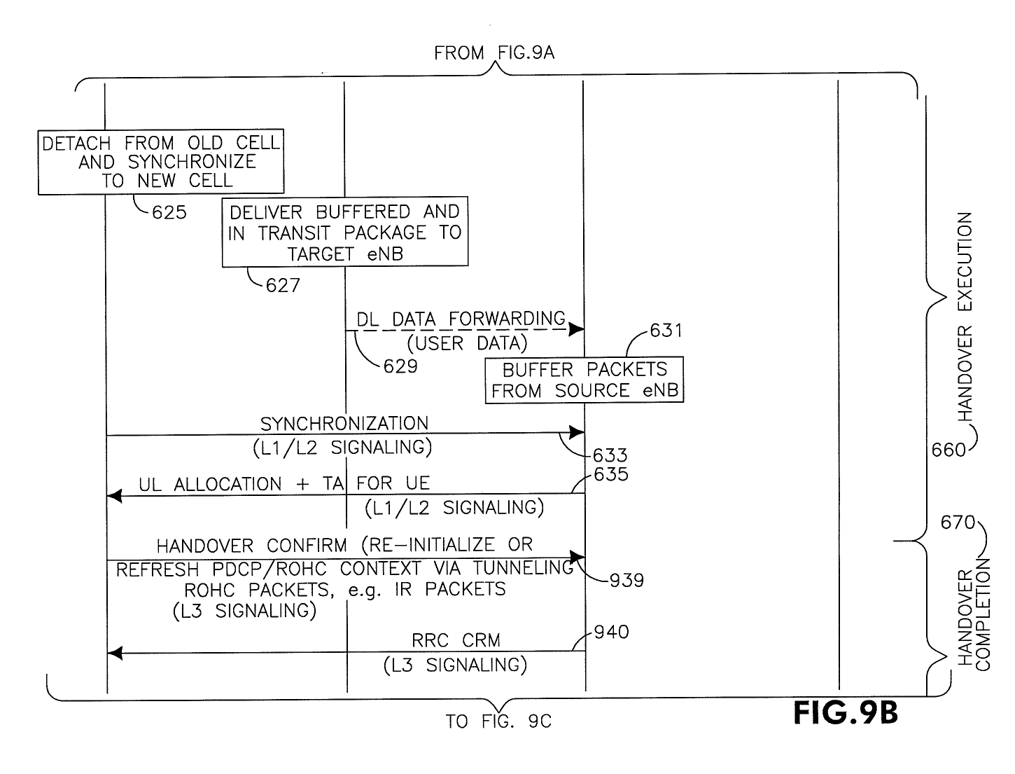

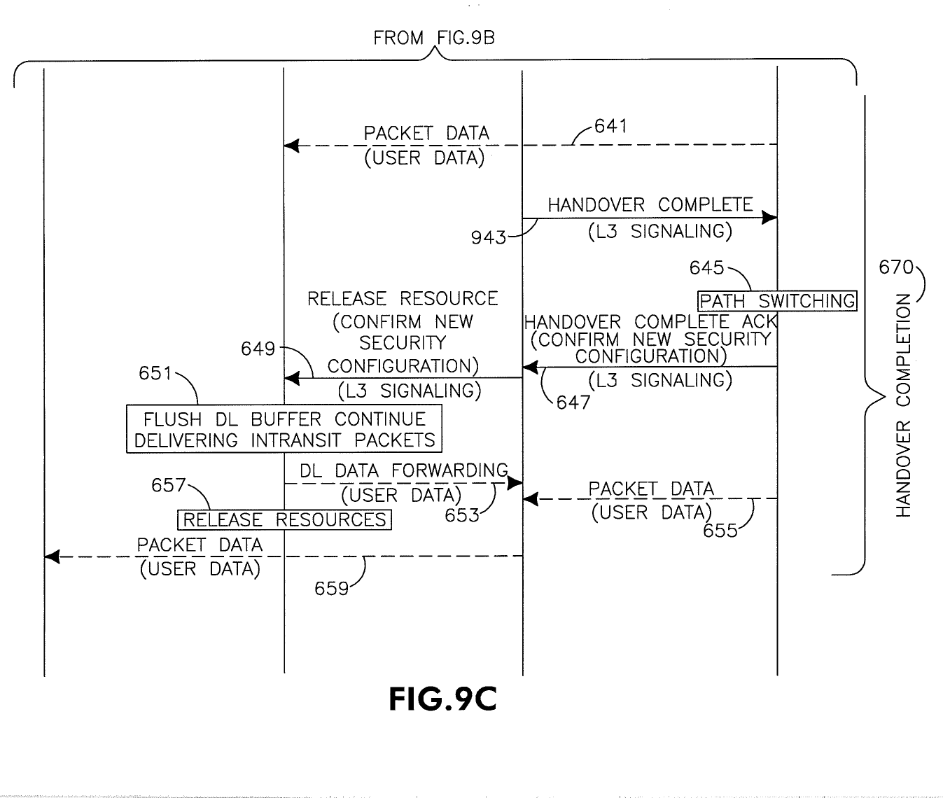

In another embodiment, referring to FIGS. 9A-9C, the source eNB 620 forwards all associated security contexts and the WTRU 610 is handed off to the target eNB 630. The target eNB 630 sends the HO complete 943 message to the MMEISAE Gateway 640 on successful completion of handover. The MMEISAE Gateway 640, at this point, may choose to re-initialize security parameters by triggering a NAS User Authentication Request or may initiate a Security Mode Command. Optionally the MME ISAE Gateway 640 may use the Handover Complete Ack message 647 to indicate any reconfiguration of security parameters. The trigger for this decision may be automatic (i.e.: upon HO) or context-based.

In all the cases described above additional security (or PDCP) contexts potentially exist (that can be transferred between eNBs) that measure the last time that the parameters were reconfigured. As an example, such a context may take the form of a timer or a count of the number of cells in which the parameters have been re-used. The source and/or target eNB can use this additional context to decide whether to re-initialize or change parameters.

Procedures for Transferring or Re-Initializing ROHC Context

In another embodiment, referring to FIGS. 9A-9C, the ROHC context is transferred. During the HO preparation stage 650, the source eNB 620 provides the target eNB 630 with the current ROHC context in its HO Request message 913 to the target eNB 630. In the HO Request Ack message 917, the target eNB 630 provides an indication of whether ROHC context transfer has been accepted (was successful) or not. The success or lack thereof may be caused by an intermittent problem/failure, a lack of resources, or a target eNB that is not capable of supporting context transfer.

In another embodiment, continuing to refer to FIGS. 9A-9C, the source eNB 620 knows (a priori) whether a target eNB 630 (or any other eNB to which it is connected) supports context transfer and at what level(s) (e.g. ROHC, Security, RLC contexts, etc.) via configuration during network deployment or via dynamically exchanging eNB capability messages. Consequently, the source eNB 620 will know in advance whether a certain target eNB 630 supports ROHC context transfer, and based on that, decide whether or not to include the current ROHC context in its HO Request message 913 to the target eNB 630.

The HO Command 921 includes an indication to the WTRU 610 on whether ROHC context transfer to the target eNB 630 has been successfully achieved or not (or alternatively, on whether the WTRU 610 should re-initialize its ROHC context or not). The WTRU 610 checks the indication included in the HO Command 921: if it indicates successful context transfer, the WTRU 610 continues with the current ROHC context; else, it re-initializes the ROHC context. Such an indication may either be explicit, or may be implied from the existence (or nonexistence) of other information.

Additionally, some or all ROHC context information may be sent as part of a separate context transfer procedure, subsequent to the reception of the HO Request Ack message 917, similar to the procedure shown in messages 703 and 705 in FIGS. 7A-7C.

In another embodiment, the ROHC is re-initialized using one or more of the following as depicted in FIGS. 9A-9C:

(a) The target eNB 620 re-initializes the ROHC context concerning downlink traffic by tunneling ROHC packet(s) such as incremental redundancy (IR) packets, or any other ROHC packet, as part of the HO Request Ack message 917 (e.g. in the transparent container to be sent to the WTRU 610 as part of the HO Command 921). The ROHC packet(s) is subsequently sent/tunneled as part of the HO Command 921.

(b) The WTRU 610 may respond to the ROHC packet(s) received from (a) above by sending ROHC packet(s) such as acknowledgement, or may send any other ROHC packet, as part of the HO Confirm message 939.

(c) The WTRU 610 re-initializes the ROHC context concerning uplink traffic by tunneling ROHC packet(s) such as IR packets, or any other ROHC packet, as part of the HO Confirm message 939.

(d) The target eNB 630 may respond to the ROHC packet(s) received from (c) above by sending ROHC packet(s) such as acknowledgement, or may send any other ROHC packet, as part of a new signaling message, a RRC connection reconfiguration message (RRC CRM) 940 depicted in FIGS. 9A-9C.

Additionally, some or all ROHC context information or ROHC packets may be sent as part of a separate context transfer procedure subsequent to the reception of the HO Request Ack message 917, similar to the procedure shown in messages 703 and 705 in FIGS. 7A-7C.

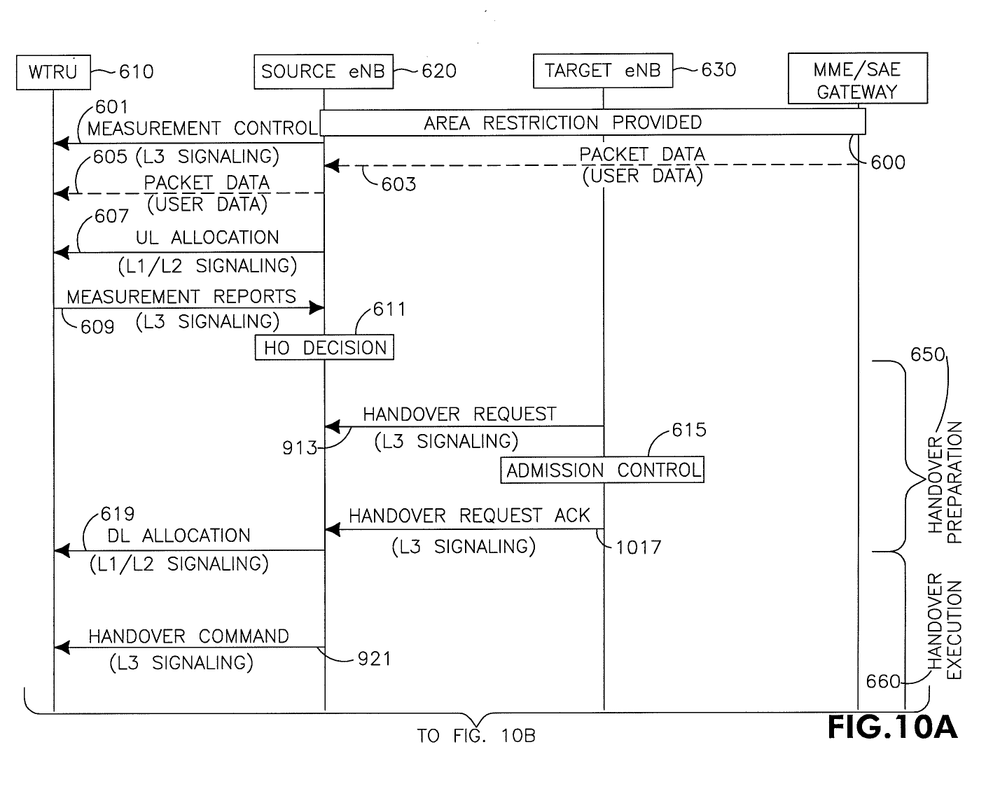

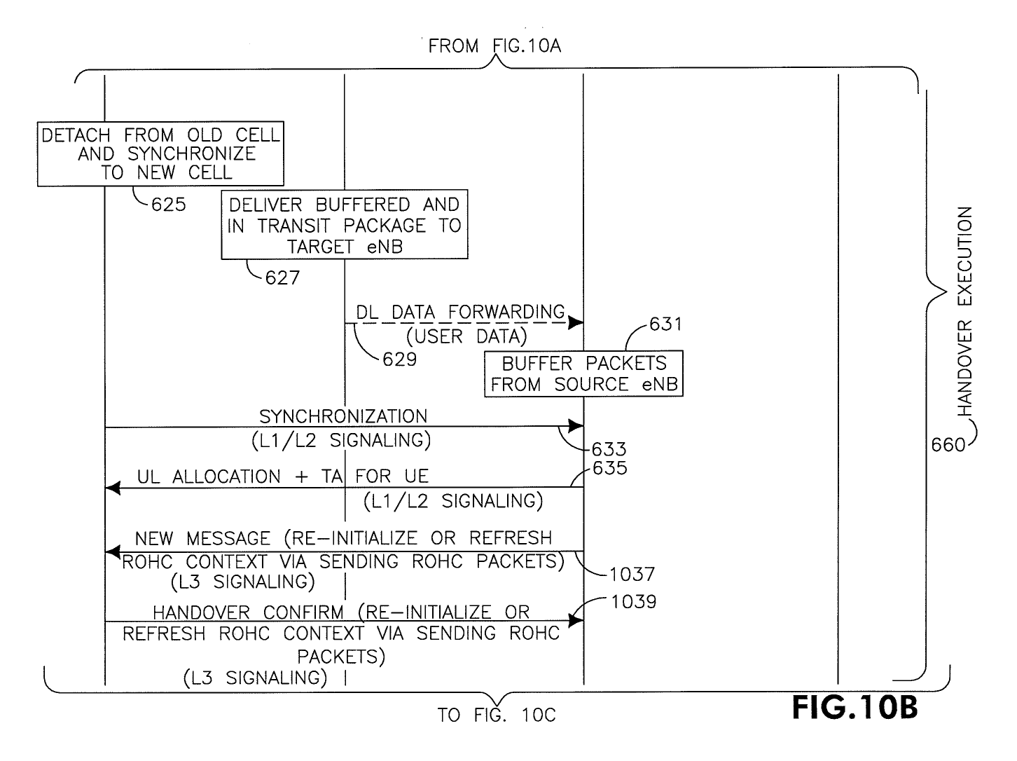

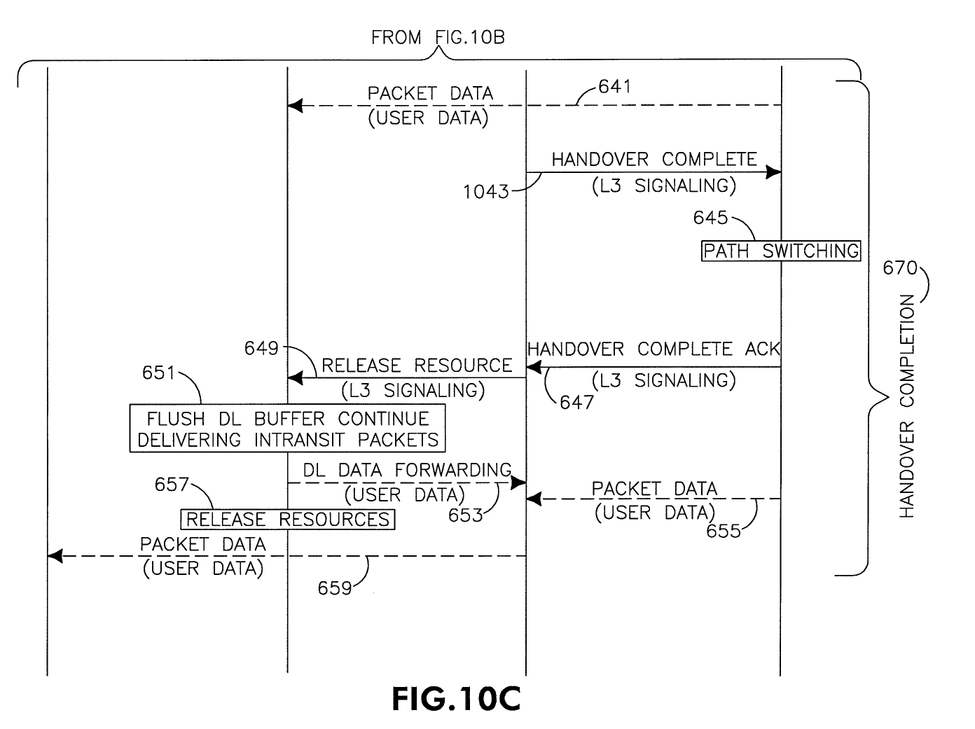

Alternatively, instead of relaying the ROHC packet(s) as part of the existing HO-related messages, one or more additional messages can be added to carry the ROHC packet(s) or ROHC context information. For example FIGS. 10A-10C, shows a new message whereby:

The target eNB 630 re-initializes the ROHC context concerning downlink traffic by tunneling ROHC packet(s) such as IR packets, or any other ROHC packet, as part of a “new message” 1037. It is possible to optimize the use of the wireless medium by merging or sending any “new messages” 1037 along with any existing messages.

Therefore, the WTRU 610 and the target eNB 630 will exchange ROHC packet(s) or ROHC context information during the “HO Execution” 660 or “HO Completion” 670 phases of the HO procedure in order to speed up the re-initializing of the ROHC context. This exchange may be in addition to, or in lieu of the exchange occurring during the “HO Preparation” 650 phase.

Some or all of the previous methods (e.g. those described re-initializing the ROHC Context) may also be applied in order to refresh the existing ROHC context instead of re-initializing it. Context refresh may be triggered automatically by a HO event. It may be based on network's preferences or configurations. It may alternatively be based on a UE's preference or capability that is conveyed during a prior initial exchange of capability or preference information.

Similar to the re-initialization case, FIGS. 9A-9C and FIGS. 10A-10C illustrate how fast context refresh can be achieved.

The HO Command 921 may also provide an indication to the WTRU 610 on whether it should re-initialize its context or not. In general, the HO Command 921 or any L3 message sent from the source eNB 620 to the WTRU 610 or target eNB 630 to the WTRU 610 during the HO procedure, includes one or more of the following indications:

1. Whether the existing context was successfully transferred
2. Whether the context is to be re-initialized
3. Whether the context is to be refreshed

Such indications may be provided as two separate indications for uplink and downlink traffic contexts. Some of those conditions may be combined in one indictor (e.g. a single indication of whether the context has been transferred or should be re-initialized).

Similarly, the HO Confirm message 1039 or any L3 message sent from the WTRU 610 to the source eNB 620 or target eNB 630 during the HO procedure includes one or more of the following indications, based on the WTRU 610 preference or capability, or based on its decision at the moment:

1. Whether the context is to be transferred
2. Whether the context is to be re-initialized
3. Whether the context is to be refreshed

If such information is conveyed in the HO Confirm message 1039, then the transfer, re-initialization or refresh of the context will take place during the later stages of the HO procedures or even after the HO procedure is complete, but this method will not be as fast as previously disclosed methods.

In addition to, or in lieu of the previous additional content to the HO messages, the information may be signaled, instead, during initial capability message exchanges that define the behavior or preference of the WTRU 610 during HO. Such capability/preference messages belong to or are part of (preferably) the Radio Resource Control (RRC) layer. For example, a capability and/or preference indication could be added to capability/preference messages that specify for a particular WTRU 610, and (optionally) for particular Radio Bearers:

1. Whether the context is to be transferred
2. Whether the context is to be re-initialized
3. Whether the context is to be refreshed

Finally, variations on the previous procedures could be designed where only the context pertaining to the downlink traffic (or uplink traffic) will be re-initialized, while that of the uplink traffic will not be re-initialized.

Procedures for Transferring or Re-Intitializing PDCP SN Context

In order to support lossless handover for LTE, the PDCP SN context needs to be transferred, at least for those services (e.g. Radio Bearers) that require lossless HO, while for the other Radio Bearers, the PDCP SN will be re-initialized (e.g. reset) at handover.

The transfer of PDCP SN context will occur between the source eNB 620 and target eNB 630 utilizing HO messages such as the HO Request message 913.

The transfer of PDCP SN context will be communicated between WTRU 610 and, source eNB 620 and target eNB 630, utilizing HO messages such as the HO Command 921 and HO Confirm 1039 (FIGS. 10A-10C) messages. The source eNB 620 and target eNB 630, may send/include the UL_Receive PDCP SN and/or DL_Send PDCP SN along with the HO Command 921 of FIGS. 9A-9C or along with the new message 1037 of FIGS. 10A-10C; also, the WTRU 610 may send may send/include the DL_Receive PDCP SN and/or UL_Send PDCP SN along with the HO Confirm message 939 of FIGS. 9A-9C or HO Confirm message 1039 of FIGS. 10A-10C.

For those services (e.g. Radio Bearers) that do not require lossless HO, (examples of those are radio bearers utilizing unacknowledged mode (UM) RLC mode or transparent mode (TM) RLC mode) the PDCP SN can be re-initialized (e.g. reset) automatically upon detecting a HO event, or upon sending or receiving a HO procedure message such as the HO Confirm message.

Additional indications may be added to the HO Command, HO Confirm or to any other HO procedure messages, to indicate whether the PDCP SN context will/shall be continued or will/shall be re-set.

Handling Failure Cases

The methods of this section apply to both security and PDCP/ROHC context. In some cases, the HO procedure may fail to complete due to a failure or problem in performing one or more of the HO procedure steps. For example, the WTRU may fail to access the target cell (target eNB).

In all cases, the WTRU maintains/stores its old context information as a backup, in order to revert back to the previous state in case of failure. Alternatively, the WTRU can defer the update of its new context until after the HO has successfully completed (e.g. upon sending the HO Confirm message).

For example, in FIGS. 9A-9C, if the WTRU 610 has received the HO Command 921 containing the information/messages to establish the new ROHC context, but has failed to access the target cell, then the WTRU 610 can revert to its stored previous ROHC context. The trigger to reload the previous context would be the detection of a failure event by the WTRU 610.

The WTRU has preference or capability information that indicates whether the WTRU would prefer (is capable) of reverting to the old (security or ROHC) context, or would prefer to re-initialize the context during failure scenarios. Such preference or capability may be exchanged during a prior initial exchange, or may be indicated in any message.

Upon failure, the WTRU may go back and make access on its previous cell or a cell belonging to its source eNB. Or the WTRU may reselect and make access on a cell belonging to a new eNB.

Upon failure, the WTRU may first go back to its old cell, attempt to access it and send a message (e.g. a HO failure message) that includes a WTRU ID (e.g. the UTRAN Radio Network Temporary Identifier (U-RNTI) equivalent, or the old and/or new Cell Radio Network Temporary Identifier (C-RNTI), etc.). Optionally, the WTRU may indicate in that message (or beforehand during WTRU capability negotiations) whether it can continue with the old context or re-initialize it (or refresh it). The eNB (or MME/SAE Gateway) will attempt to retrieve/recover the UE's old context, and will send a message to the WTRU indicating whether the WTRU can continue with the old context or not.

If the WTRU is unsuccessful in accessing its old cell, the WTRU may reselect to another cell, access it and send a message (e.g. a cell update message) that includes a WTRU ID (e.g. the U-RNTI equivalent, or the old and/or new C-RNTI, or paging group ID, or discontinuous reception (DRX) group ID, or pool or tracking area ID, or any suitable ID). Optionally, the WTRU may indicate in that message (or beforehand during WTRU capability negotiations) whether it can continue with the old context or it would want to re-initialize it (or refresh it). The eNB (or network) will attempt to retrieve/recover the UE's old context from the network (e.g. from the source eNB or target eNB), and will send a message (e.g. a cell update confirm message) to the WTRU with an indication of whether the WTRU can continue with the old context or should re-initialize it. If the context is to be re-initialized, the WTRU may tunnel the context establishment/initialization messages along with the cell update messages. Similarly, the eNB may tunnel the context establishment/initialization messages along with the cell update confirm message. The above will result in fast re-initialization of the context in such failure scenarios.

The above behavior may be standardized rather than WTRU controlled. It may also be dependent upon network configurations. For example, a default behavior could be standardized whereby during failure the context is continued (or reused) if the WTRU goes back to its old cell, while the context is re-initialized if the WTRU reselects to a new cell.

In the special case where the new cell also belongs to the same old eNB, then either approach can be used, but the preferred approach is to treat this in a manner similar to the case of going back to the old cell, since it should be feasible to retrieve the old context information relatively quickly and continue with the old context.

The target eNB can utilize a timer mechanism whereby the transferred context information will be discarded if the WTRU does not make access on the target eNB before the expiration of the timer. Alternatively, following a failure, if the WTRU connects to a particular cell/eNB (e.g. its original cell or eNB), then such eNB can notify the target eNB of such event to enable the target eNB to discard the transferred context information.

Although HO failure, cell update, and cell update confirm messages have been disclosed, the WTRU may utilize different messages, or messages with different names to convey the information during the procedures previously described, such as any L3 or RRC message, or any signaling message in general.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for implementing security context transfer by a wireless transmit and receive unit (WTRU) during handover, comprising:
receiving a handover command including an indication of an intention to change a security configuration;
receiving a security context;
receiving a Packet Data Convergence Protocol (PDCP) context;
processing the security context and the PDCP context and generating corresponding changes to the security context of the WTRU; and
transmitting a handover confirmation in accordance with the processing.

2. The method of claim 1 wherein the receiving an indication comprises at least one of an indication of an intention to change the control plane security procedure, an indication of an intention to change the user plane security procedure, an indication of an intention to change the control plane data integrity protection procedure, and an indication of an intention to change the user plane data integrity protection procedure.

3. The method of claim 1 wherein the receiving the security context is via an uplink allocation message.

4. The method of claim 1 wherein the receiving the security context is via a Handover Command.

5. The method of claim 1 wherein the receiving the security context includes at least one of a control plane signaling ciphering key, a control plane signaling integrity protection key, a user plane data ciphering key, a user plane data integrity protection key, a control plane signaling ciphering procedure, a control plane signaling integrity protection procedure, a user plane data ciphering procedure, a user plane data integrity protection procedure, and a parameter enabling the derivation of a key.

6. The method of claim 1 wherein the receiving the security context includes a ciphering information element further including a ciphering status indication and a ciphering procedure indication.

7. The method of claim 1 wherein the receiving the security context includes an integrity protection information element further including an integrity protection status indication and an integrity protection procedure indication.

8. The method of 1 wherein the receiving the security context comprises a Start parameter.

9. The method of claim 1 wherein the receiving the security context further comprises receiving a Fresh parameter.

10. The method of claim 1 wherein the transmitting the handover confirmation comprises transmitting a Start parameter.

11. The method of claim 1 wherein the sending the handover confirmation comprises confirming the security configuration wherein the confirming comprises:
sending a success indicator;
sending the security context or an element of the security context.

12. The method of claim 1 wherein receiving the handover command and receiving the PDCP context is from an evolved Node B (eNB).

13. The method of claim 1 wherein the receiving the context transfer is from an evolved Node B (eNB) and the sending the handover confirm is from an eNB.

14. A method for implementing reverse tunneling of a security context by a wireless transmit and receive unit (WTRU) during handover, comprising:
receiving a handover command further comprising a security context; and
transmitting a handover confirmation in accordance with the received handover command.

15. The method of claim 14 wherein the receiving a handover command comprises receiving a Packet Data Convergence Protocol (PDCP) context.

16. The method of claim 14 wherein the receiving the security context includes at least one of a control plane signaling ciphering key, a control plane signaling integrity protection key, a user plane data ciphering key, a user plane data integrity protection key, a control plane signaling ciphering procedure, a control plane signaling integrity protection procedure, a user plane data ciphering procedure, a user plane data integrity protection procedure, and a parameter enabling the derivation of a key.

17. The method of claim 14 wherein the receiving the security context includes a ciphering information element further including a ciphering status indication and a ciphering procedure indication.

18. The method of claim 14 wherein the receiving the security context includes an integrity protection information element further including an integrity protection status indication and an integrity protection procedure indication.

19. The method of claim 14 wherein the transmitting the handover confirmation comprises confirming the security configuration wherein the confirming comprises:
sending a success indicator; and
sending the security context or an element of the security context.

20. The method of claim 14 wherein the transmitting the handover confirmation comprises sending a Start parameter.

21. A method for implementing context transfer by a WTRU during handover, comprising receiving a handover command containing security context including ciphering keys and integrity protection keys.

22. The method of claim 21 wherein the security context comprise at least one of a control plane signaling ciphering key, a control plane signaling integrity protection key, a user plane data ciphering key, a user plane data integrity protection key, a control plane signaling ciphering procedure, a control plane signaling integrity protection procedure, a user plane data ciphering procedure, a user plane data integrity protection procedure, and a parameter enabling the derivation of a key.

23. The method of claim 21 further comprising sending a handover completion confirmation message wherein the confirming comprises:
sending a success indicator; and
sending the security context or an element of the security context.

24. A method for implementing Robust Header Compression (ROHC) reinitialization, the method comprising receiving an indication that the context transfer has been successful or not successful.

25. The method of claim 24 further comprising reinitializing the ROHC context if the indication indicates that the context transfer was not successful.

26. The method of claim 24 further comprising not reinitializing the ROHC context if the indication indicates that the context transfer was successful.

27. A method of reinitializing a ROHC context by a WTRU, the method comprising sending a handover confirm message including any of a ROHC context, and a ROHC packet.

28. A method of reinitializing a ROHC context by a WTRU, the method comprising sending, during a handover execution phase, at least one of a ROHC context and a ROHC packet.

29. The method of claim 28 further comprising sending, during a handover completion phase, at least one of a ROHC context, and a ROHC packet.

30. A method of reinitializing a ROHC context by a WTRU, the method comprising receiving a handover command including at least one of a ROHC context, and a ROHC packet.

31. A method of reinitializing a PDCP SN context by a WTRU, the method comprising:
checking whether the bearer is an acknowledged mode bearer;
reinitializing the PDCP SN context upon a HO event if bearer is an unacknowledged mode bearer or a transparent mode bearer.

32. A method of reinitializing a PDCP SN context by a WTRU, the method comprising receiving a HO procedure message including an indication of whether to re-initialize the PDCP SN context or continue with the PDCP SN context.

33. A wireless transmit and receive unit (WTRU) configured to implement a security context transfer during handover, comprising:
a receiver configured to receive a handover command including an indication of an intention to change a security configuration, a security context, and a Packet Data Convergence Protocol (PDCP) context;
a processor configured to process the security context and the PDCP context and generate any corresponding changes to the security context of the WTRU; and
a transmitter configured to send a handover confirmation in accordance with the processing.

34. The WTRU of claim 33 wherein the receiver of the processor is further configured to receive an indication comprising at least one of an indication of an intention to change a control plane signaling ciphering procedure, an indication of an intention to change a user plane ciphering security procedure, an indication of an intention to change a control plane signaling integrity protection procedure, and an indication of an intention to change a user plane data integrity protection procedure.

35. The WTRU of claim 33 wherein the security context comprises at least one of a control plane signaling ciphering key, a control plane signaling integrity protection key, a user plane data ciphering key, a user plane data integrity protection key, a control plane signaling ciphering procedure, a control plane signaling integrity protection procedure, a user plane data ciphering procedure, a user plane data integrity protection procedure, and a parameter enabling the derivation of a key.
